(19) United States
(12) Patent Application Publication
(10) Pub. No.: US 2024/0094984 A1
(43) Pub. Date: Mar. 21, 2024

(54) SYNCHRONIZATION OF AUDIO OUTPUT FOR NOISE CANCELLATION

(71) Applicant: Comcast Cable Communications, LLC, Philadelphia, PA (US)

(72) Inventors: Scott KURTZ, Mount Laurel, NJ (US); Michael SALLAS, Radnor, PA (US)

(21) Appl. No.: 17/932,761

(22) Filed: Sep. 16, 2022

(51) Int. Cl. G06F 3/16; G10L 15/01

(52) U.S. Cl. CPC G06F 3/167; G10L 15/01

(57) ABSTRACT

A first computing device may comprise at least one audio output and at least one audio input. The first computing device may determine a first delay associated with output of first audio from a second computing device located remote to the first computing device. Output of second audio may be caused via the at least one audio output based on the first delay. An audio input signal comprising the first audio, the second audio, and third audio indicative of a voice command may be received via the at least one audio input. At least one action may be caused to be performed based on the voice command. The at least one action may be caused to be performed based on removal of the first audio and the second audio from the audio input signal.

### BACKGROUND

Voice recognition systems and devices configured to receive and respond to voice queries are becoming increasingly common. A voice query may be, for example, a spoken command to the device to perform some action, a spoken request to view or play some particular content, a spoken request to search for certain content or information based on search criteria, or any other spoken request or command that may be spoken by a user. However, when such a device attempts to capture audio for the purpose of speech recognition, the accuracy of the speech recognition can be degraded by audio emanating from an output device (e.g., a television), audio emanating from the device itself, or audio emanating from any other audio source that is located in close proximity to the device. Therefore, improvements in noise cancellation techniques are desirable.

### SUMMARY

Methods and systems are disclosed herein for noise cancellation techniques. A device may be configured to receive and respond to voice commands or queries. The voice commands or queries received at the audio input of the device may be interfered with by audio from output devices such as nearby televisions or audio systems. The voice commands or queries received at the audio input of the device may also be interfered with by audio output by its local audio output. These interference signals may degrade the voice command received by the audio input. The techniques disclosed herein synchronize the interference signals so that they can be effectively cancelled from the audio received by the audio input thereby enabling the voice command to be processed properly. Synchronizing the interference signals may be accomplished by delaying the output of the audio to the local audio output such that it is time aligned with the audio received by the audio input from the nearby output devices (e.g., a television). The system may cancel the synchronized interference signals from the audio captured by the audio input and process the voice command or query.”

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to features that solve any or all disadvantages noted in any part of this disclosure.

### BRIEF DESCRIPTION OF THE DRAWINGS

The following detailed description is better understood when read in conjunction with the appended drawings. For the purposes of illustration, examples are shown in the drawings; however, the subject matter is not limited to specific elements and instrumentalities disclosed. In the drawings:

FIG. 1 shows an example system;

FIG. 2 shows another example system;

FIG. 3 shows an example method for noise cancellation;

FIG. 4 shows another example method for noise cancellation;

FIG. 5 shows another example method for noise cancellation; and

FIG. 6 shows an example computing device.

### DETAILED DESCRIPTION OF ILLUSTRATIVE EMBODIMENTS

When a device, such as a set-top box (STB), that is configured to perform voice recognition receives a voice query or command from a user, the device may process the voice query or command to determine the meaning of what the user uttered. For example, a user may speak a voice command, such as “tune to channel 4.” The voice command may be captured by one or more audio inputs (e.g., microphones) of the device. The device may forward audio data associated with the captured voice command to a processor (e.g., a voice recognition engine) that is configured to determine the voice command and respond accordingly. For example, the processor may process the audio data associated with a captured voice command to determine that the user wants to tune to channel 4. The device may respond to the voice command, for example, by causing tuning to the desired channel (i.e., channel 4).

However, if additional audio or noise was also captured by the microphone(s) at the time that the voice command was captured, such additional audio or noise may degrade the processor's ability to determine the voice command. Such additional audio or noise (hereinafter referred to as “interference audio”) may emanate from a variety of different audio sources, such as televisions, radios, talkers, and/or any other audio source located proximate to the device. Voice recognition devices themselves may comprise local audio outputs, such as speakers (e.g., an STB with a local speaker or a speaker phone). If the voice recognition device itself includes one or more audio outputs (e.g., one or more “local speakers”), interference audio may additionally, or alternatively, emanate from the local speakers.

Voice recognition devices may include Acoustic Echo Cancellers (AECs) that reduce degradation due to interference audio. An AEC may reduce such degradation by cancelling out the interference audio signal from the microphone input signal. For example, a voice recognition device may receive, at one or more microphones, both a voice command and interference audio. The voice command audio signal and the interference audio signal (collectively, the “microphone input signal”) may be forwarded to an AEC. The AEC may cancel out the interference audio signal from the microphone input signal, so that the voice command audio signal remains, but all or substantially all of the interference audio signal has been cancelled out. The voice command audio signal may then be forwarded to a processor that is configured to determine the voice command and respond accordingly. As the AEC has cancelled out the interference audio signal from the microphone input signal, the interference audio signal may not interfere with the processor's ability to determine the voice command.

Interference audio may emanate from more than one audio source. For example, one or more microphones of a voice recognition device may capture a voice command, first interference audio emanating from an output device (e.g., a television), and second interference audio emanating from one or more local speakers (collectively, the “microphone input signal”). The AEC may not be able to properly filter out the first and second interference audio from the microphone input signal if the first and second interference audio signals are not received at the one or more microphones at approximately the same time.

For example, the one or more microphones may receive, for the first interference audio, a first microphone input. The first microphone input may be a first impulse response having a first echo tail. The first echo tail may reflect the reverberation characteristics and reverberation time of the room acoustics. The amount of time that it takes the first impulse response to settle down may be referred as the first echo tail length. Likewise, the one or more microphones may receive, for the second interference audio, a second microphone input. The second microphone input may be a second impulse response having a second echo tail. The second echo tail may reflect the reverberation characteristics and reverberation time of the room acoustics. The amount of time that it takes the second impulse response to settle down may be referred as the second echo tail length.

If the first and second interference audio signals are not received by the one or more microphones at the same time, the AEC may need to cancel both the first and second echo tails. For example, the AEC may need to cancel the echo over the delay spread of both the first and second echo tail lengths. Cancelling two independent echo tails may increase the amount of work that needs to be performed by the AEC. Additionally, or alternatively, cancelling two independent echo tails may make it more difficult for the AEC to fully cancel out the first and second interference audio from the microphone input signal.

If the AEC is not able to fully cancel out the first and second interference audio from the microphone input signal, the audio signal sent to the processor may include both the voice command audio signal and a remaining interference audio signal. The remaining interference audio signal may interference with the processor's ability to determine the voice command. Thus, it is desirable for the first interference audio and the second interference audio to reach the microphone(s) simultaneously, or substantially at the same time (e.g., within a range of a few seconds or milliseconds) so that the AEC is able to properly filter out the first and second interference audio from the microphone input signal.

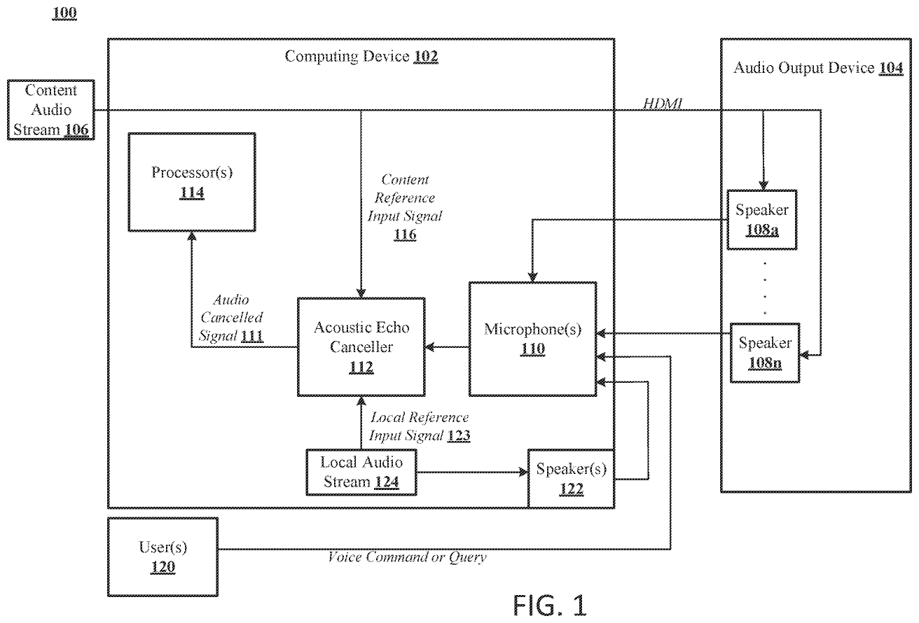

FIG. 1 illustrates an example system 100 in which the methods and apparatus described herein may be implemented. Such a system 100 may comprise a device 102, an audio output device 104, and one or more users 120.

The device 102 may be any device configured to perform voice recognition. For example, the device 102 may be configured to receive a voice query or a voice command from the user(s) 120. In response to receiving the voice query or the voice command, the device 102 may be configured to process the voice query or voice command to determine the meaning of what the user uttered. The device 102 may be configured to detect a keyword or a wake-word. If the device 102 detects a keyword or a wake-word, the device 102 may send the voice query or voice command audio to a remote device or processor. The remote device or processor may be configured to process the voice query or voice command to determine the meaning of what the user uttered. The device 102 may be configured to respond to the voice query or voice command accordingly. For example, the device 102 may be configured to cause some action to be performed in response to the voice query or voice command.

The device 102 may comprise a set-top box, a wireless gateway, a desktop computer, a laptop computer, a handheld computer, a tablet, a netbook, a speaker phone, a smartphone, a gaming console, or any other computing device capable of operating in a wireless or wired network. The device 102 may comprise transmitters, receivers, and/or transceivers for communicating via a wireless or wired network.

The device 102 may receive a content audio stream 106, such as from a content provider or cable network. The content audio stream 106 may be decoded after being received from the content provider or cable network. For example, the device 102 may receive the content audio stream 106 via a coax cable or from an IP-based connection. The content audio stream 106 may be associated with the audio portion of content. The content may additionally include a video portion. If the content includes a video portion, the device 102 may receive a corresponding content video stream, such as from the content provider or cable network. For example, the content audio stream 106 may additionally include the corresponding content video stream.

As used herein, “content” may refer to any of linear content, non-linear content, multi-media content, recorded content, stored content, or any other form of content a user may wish to consume. Content may refer generally to any content produced for viewer consumption regardless of the type, format, genre, or delivery method. Content may comprise content produced for broadcast via over-the-air radio, cable, satellite, or the internet. Content may comprise digital video content produced for digital video streaming or video-on-demand. Content may comprise a movie, a television show or program, an episodic or serial television series, or a documentary series, such as a nature documentary series. As yet another example, content may include a regularly scheduled video program series, such as a nightly news program. The content may be associated with one or more content providers that distribute the content to viewers for consumption.

The device 102 may be part of a content distribution network operated by a content provider, such as a cable television provider, a streaming service, a multichannel video programming distributor, a multiple system operator, or any other type of service provider. The device 102 may be configured to cause output of the content via the audio output device 104. For example, the device 102 may be configured to cause output of the audio stream 106, via one or more speakers of the audio output device 104. To cause output of the audio stream 106 via the audio output device 104, the device 102 may send the content audio stream 106 via High-Definition Multimedia Interface (HDMI) to the audio output device 104. The content audio stream 106 may comprise one or more audio channels. For example, the content audio stream 106 may comprise a quantity of audio channels corresponding to a quantity of speakers associated with the audio output device 104.

The audio output device 104 may include a television, a smart television, a desktop computer, a laptop computer, a handheld computer, a tablet, a netbook, a smartphone, a gaming console, or any other device capable of operating in a wireless or wired network and outputting audio. The audio output device 104 may comprise one or more speakers 108a-n. The audio output device 104 may receive the content audio stream 106 from the device 102 and output the content audio via the speakers 108a-n. If the content audio stream 106 is associated with content that includes a video portion, the audio output device 104 may additionally output video corresponding to the audio via one or more interfaces of the audio output device 104. Additionally, or alternatively, the video corresponding to the audio may be output via one or more interfaces of a different device.

The device 102 may include one or more local speakers 122. The speakers 122 may be configured to output local audio associated with a local audio stream 124. The local audio may include any audio, such as audible tones (e.g., beeps, etc.) or prestored messages. For example, the speakers 122 may output a noise if one or more microphones 110 included in the device 102 receive a keyword associated with a voice command. The device 102 may be configured to function as a speakerphone, and the local audio may include audio that would typically be output by a speakerphone. The device 102 may be connected to other household devices (e.g., remote control, doorbell, etc.), and the speakers 122 may output local audio associated with such household devices. The speakers 122 may be located on the device 102. Additionally, or alternatively, the speakers 122 may be located external to the speaker (i.e., part of an external sound system).

The device 102 may include one or more microphones 110. The microphone(s) 110 may receive audio indicative of a voice query or a voice command from the user(s) 120. For example, the user(s) 120 may speak a voice command or a voice query, and the voice command or query may be captured by the microphone(s) 110. The microphone(s) 110 may additionally, or alternatively, receive audio emanating from the speakers 108a-n (i.e., first interference audio) and the speakers 122 (i.e., second interference audio). For example, the microphone(s) 110 may capture audio emanating from both the speakers 108a-n and the speakers 122. The captured audio emanating from the speakers 108a-n, the captured audio emanating from the speakers 122, and the captured audio indicative of the voice command or query are collectively referred to as the microphone input signal. If the microphone(s) 110 include more than one microphone, the microphone(s) 110 may include a microphone array that is utilized in combination with one or more spatial filtering techniques to spatially filter ambient audio.

The device 102 may include an AEC 112. The device 102 may forward the microphone input signals to the AEC 112. For example, the device 102 may cause the microphone(s) 110 to send the microphone input signals to the AEC 112. The AEC 112 may receive the microphone input signals. The AEC 112 may reduce degradation due to the first interference audio and the second interference audio so that the device 102 can properly process the voice command or query. For example, the AEC 112 may accomplish this by cancelling out the audio signal indicative of the first interference audio and the audio signal indicative of the second interference audio from the microphone input signals. If the audio signal indicative of the first interference audio and the audio signal indicative of the second interference audio are cancelled out from the microphone input signals, the remaining microphone input signals may be the audio signal indicative of the voice command or query.

The AEC 112 may utilize reference signals to filter out interference audio signals from the microphone input signal. For example, the device 102 may forward a content reference input signal 116 to the AEC 112. The content reference input signal 116 may be a reference signal associated with the audio emanating from the speakers 108a-n (i.e., first interference audio). For example, the content reference input signal 116 may provide the AEC 112 with the same audio signals that are emanating from the speakers 108a-n. The content reference input signal 116 may comprise one or more audio channels. For example, the content reference input signal 116 may comprise a quantity of audio channels corresponding to a quantity of speakers 108a-n.

The AEC 112 may utilize the content reference input signal 116 and the microphone input signals to determine the echo characteristics of the content audio stream 106. For example, the AEC 112 may utilize adaptive filtering techniques to determine the echo characteristics of the content audio stream 106 based on the content reference input signal 116 and the microphone input signals. The echo characteristics of the content audio stream 106 may indicate a direct acoustic path between the speakers 108a-n and the microphone(s) 110. The echo characteristics of the content audio stream 106 may additionally, or alternatively, indicate indirect acoustic paths between the speakers 108a-n and the microphone(s) 110. Such indirect acoustic paths may be due to the reflections of the speaker output off the walls, ceiling, floor, and/or objects in the room. The indirect path may therefore diffuse (spread out over time) with decreasing amplitude as time passes.

The device 102 may additionally forward a local reference input signal 123 to the AEC 112. The local reference input signal 123 may be associated with the audio emanating from the local speakers 122 (i.e., second interference audio). For example, the local reference input signal 123 may provide the AEC 112 with the same audio signals that are emanating from the speakers 122. The AEC 112 may utilize the local reference input signal 123 and the microphone input signals to determine the echo characteristics of the local audio stream 124. The echo characteristics of the local audio stream 124 may indicate a direct acoustic path between the speakers 122 and the microphone(s) 110. The echo characteristics of the local audio stream 124 may additionally, or alternatively, indicate indirect acoustic paths between the speakers 122 and the microphone(s) 110. Such indirect acoustic paths may be due to the reflections of the speaker output off the walls, ceiling, floor, and/or objects in the room. The indirect path may therefore diffuse (spread out over time) with decreasing amplitude as time passes.

As described above, the AEC 112 may utilize the reference signals to learn the echo characteristics of the interference audio signals. By learning the echo characteristics of the interference audio signals, the AEC 112 may be able to differentiate the interference audio from the voice command. In this manner, the AEC 112 may be able to filter out the interference audio signals, but not the audio signal indicative of the voice command or query, from the microphone input signal.

The device 102 may include one or more processor(s) 114. The device 102 may forward the filtered microphone input signal (i.e., the audio cancelled signal 111) to the processor(s) 114. For example, the device 102 may cause the AEC 112 to send the audio cancelled signal 111 to the processor(s) 114. The processor(s) 114 may receive the audio cancelled signal 111. In response to receiving the audio cancelled signal 111, the processor(s) 114 may determine the meaning of the voice command or query. For example, the processor(s) 114 may employ natural language processing techniques to understand the meaning of the voice command or query. The device 102 may respond to the voice query or voice command accordingly. For example, the device 102 may be perform one or more actions and/or cause one or more actions to be performed in response to the voice query or voice command

While FIG. 1 shows the example device 102, the example device 104, and the example AEC 112 as one computing device, the device 102, the audio output device 104 and/or the AEC 112 may each be implemented in one or more computing devices. Such a computing device may comprise one or more processors and memory storing instructions that, when executed by the one or more processors, cause the computing device to perform one or more of the various methods or techniques described here. The memory may comprise volatile memory (e.g., random access memory (RAM)) and/or non-volatile memory (e.g., a hard or solid-state drive). The memory may comprise a non-transitory computer-readable medium. The computing device may comprise one or more input devices, such as a mouse, a keyboard, or a touch interface. The computing device may comprise one or more output devices, such as a monitor or other video display. The computing device may comprise an audio input and/or output. The computing device may comprise one or more network communication interfaces, such as a wireless transceiver (e.g., Wi-Fi or cellular) or wired network interface (e.g., ethernet).

However, as described above, the AEC 112 may not be able to properly filter out the first and second interference audio from the microphone input signal if the first and second interference audio signals are not captured by the microphone(s) 110 at the same time. For example, if the first and second interference audio signals are not captured by the microphone(s) 110 at the same time, the AEC 112 may need to cancel two independent echo tails. Cancelling two independent echo tails may increase the amount of work that needs to be performed by the AEC 112. In particular, cancelling out two independent echo tails may require the AEC 112 to utilize a long adaptive filter (e.g., an adaptive filter with a large quantity of coefficients). As the number of filter coefficients increases, the quantity of CPU cycles required to perform the computations may also increase.

Additionally, or alternatively, if the AEC 112 has to cancel out two independent echo tails, this may make it more difficult for the AEC 112 to fully filter out the first and second interference audio from the microphone input signal. In particular, as the number of adaptive filter coefficients increases, the accuracy of the adaptive filter decreases, which results in a lower degree of echo cancellation. For example, an echo canceller with N coefficients may achieve 25 dB of echo return loss enhancement whereas an echo canceller with 2N coefficients may only achieve an ERLE of 20 dB. As a result, the audio cancelled signal 111 forwarded to the processor may include both the voice command audio signal and a remaining interference audio signal. The remaining interference audio signal may interfere with the processor's ability to determine the voice command.

Additionally, or alternatively, as the number of adaptive filter coefficients increases, the adaptation rate of the adaptive rate of the filter may need to be slowed down. Otherwise, the adaptive filter may become unstable. Slowing down the adaptation rate of the filter may mean that the AEC 112 converges and reconverges more slowly. Convergence is the process of reaching a steady state of maximum cancellation from an initial state of zero cancellation. For example, it may take a few seconds to fully converge an acoustic echo canceller that has N coefficients to reach a steady state of 25 dB of echo cancellation. If the coefficients are increased to 2N coefficients, it may take twice as much time to fully converge and may only reach 20 dB of cancellation. Being able to converge quickly is especially important because echo characteristics are not static. For example, a person or object moving around the room can change the echo characteristics, at which point the echo canceller may need to reconverge. Until the echo canceller reaches a steady state of maximum cancellation again, its cancellation may be suboptimal.

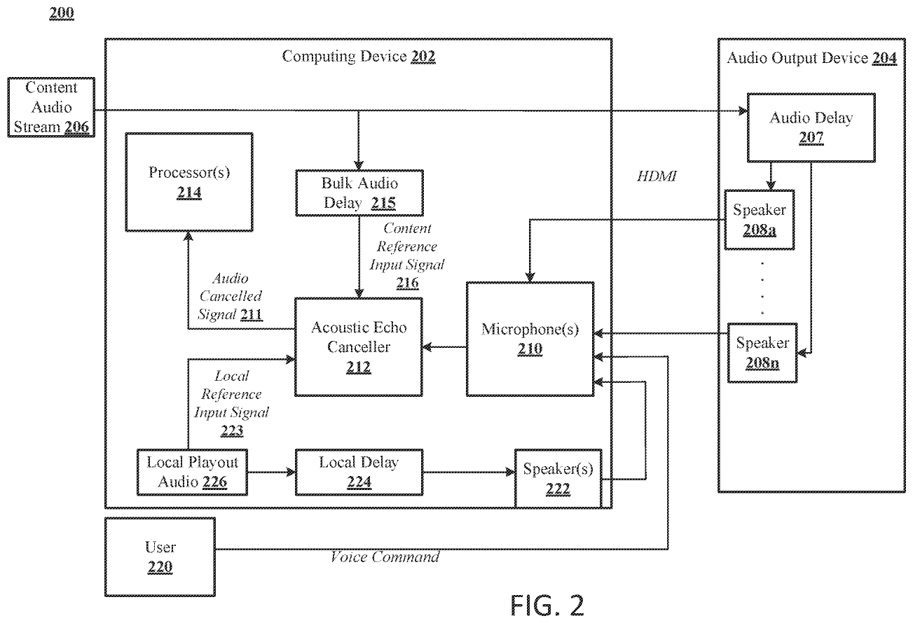

To remedy the downsides of cancelling two independent echo tails, a delay may be inserted in the local audio path. The local audio path delay may synchronize the first interference audio and the second interference audio so that they arrive at (e.g., are captured by) the microphone(s) 110 at the same time. Inserting the local audio path delay may make the cancelling out of interference audio easier, less computationally intensive, and more accurate. Such a local audio path delay is discussed in more detail below with regard to the system 200 of FIG. 2.

FIG. 2 shows an example system 200 in which the methods and apparatus described herein may be implemented. Such a system 200 may comprise a device 202, an audio output device 204, and one or more users 220.

The device 202 may be any device configured to perform voice recognition. For example, the device 202 may any device that is configured to receive a voice query or a voice command from the user(s) 220. In response to receiving the voice query or the voice command, the device 202 may be configured to process the voice query or voice command to determine the meaning of what the user uttered. The device 202 may be configured to respond to the voice query or voice command accordingly. For example, the device 202 may be configured to perform one or more actions and/or cause one or more actions to be performed in response to the voice query or voice command

The device 202 may comprise a set-top box, a wireless gateway, a desktop computer, a laptop computer, a handheld computer, a tablet, a netbook, a smartphone, a gaming console, or any other computing device capable of operating in a wireless or wired network. The device 202 may comprise transmitters, receivers, and/or transceivers for communicating via a wireless or wired network.

The device 202 may receive a content audio stream 206, such as from a content provider or cable network. For example, the device 202 may receive the content audio stream 206 via a coax cable or from an IP-based connection. The content audio stream 206 may be associated with an audio portion of content. The content may additionally include a video portion. If the content additionally includes a video portion, the device 202 may receive a corresponding content video stream, such as from the content provider or cable network.

The device 202 may be part of a content distribution network operated by a content provider, such as a cable television provider, a streaming service, a multichannel video programming distributor, a multiple system operator, or any other type of service provider. The device 202 may be configured to cause output of the content via the audio output device 204. For example, the device 202 may be configured to cause output of the audio stream 206 via one or more speakers of the audio output device 204. To cause output of the audio stream 206 via the audio output device 204, the device 202 may send the content audio stream 206 via High-Definition Multimedia Interface (HDMI) to the audio output device 204. The content audio stream 206 may comprise one or more audio channels. For example, the content audio stream 206 may comprise a quantity of audio channels corresponding to a quantity of speakers associated with the audio output device 204.

The audio output device 204 may be any device that is configured to output audio. For example, the audio output device 204 may include a television, a smart television, a desktop computer, a laptop computer, a handheld computer, a tablet, a netbook, a smartphone, a gaming console, or any other device capable of operating in a wireless or wired network and outputting audio.

The audio output device 204 may comprise one or more speakers 208a-n. The one or more speakers 208a-n may be located on the audio output device 204. Additionally, or alternatively, the one or more speakers 208a-n may be located remotely from the audio output device 204. The audio output device 204 may receive the content audio stream 206 from the device 202 and output the content audio via the speakers 208a-n. If the content audio stream 206 is associated with content that includes a video portion, the audio output device 204 may additionally output video corresponding to the audio via one or more interfaces of the audio output device 204. Additionally, or alternatively, the video corresponding to the audio may be output via one or more interfaces of a different device.

Output of the content audio via the audio output device 204 may be delayed. For example, there may be a delay 207 between the device 202 sending the content audio stream 206 to the audio output device 204 and the audio output device 204 actually outputting the content audio via the speakers 208a-n. The delay 207 may, for example, result from the time that it takes the audio output device 204 to process the video and/or audio before outputting the content audio.

The device 202 may include one or more speakers 222. The speakers 222 may be configured to output local audio associated with a local audio stream 224. The local audio may include any audio, such as audible tones (e.g., beeps, etc.) or prestored messages. For example, the speakers 222 may output a noise if one or more microphones 210 included in the device 202 receive a keyword associated with a voice command. The device 202 may be configured to perform full duplex communication. For example, the device 202 may be configured to function as a speakerphone, and the local audio may include audio that would typically be output by a speakerphone. The device 202 may be connected to other household devices (e.g., remote control, doorbell, etc.), and the speakers 222 may output local audio associated with such household devices. The speakers 222 may be located on the device 102. Additionally, or alternatively, the speakers 222 may be located external to the speaker (i.e., part of an external sound system).

The device 202 may include one or more microphones 210. The microphone(s) 210 may receive audio from a variety of different sources. For example, the microphone(s) 210 may receive audio indicative of a voice query or a voice command from the user(s) 220. For example, the user(s) 220 may speak a voice command or a voice query, and the voice command or query may be captured by the microphone(s) 210. The microphone(s) 210 may additionally, or alternatively, receive audio emanating from the speakers 208a-n (i.e., first interference audio). The microphone(s) 210 may additionally, or alternatively, receive audio emanating from the speakers 222 (i.e., second interference audio). For example, the microphone(s) 210 may capture both the first and second interference audio. The audio signal indicative of the first interference audio, the audio signal indicative of the second interference audio, and the audio indicative of the voice command or query are collectively referred to herein as the microphone input signal.

The device 202 may include an acoustic echo canceller (AEC) 212. The AEC 212 may reduce degradation due to the first interference audio and the second interference audio so that the device 202 can properly process the voice command or query. For example, the AEC 212 may accomplish this by cancelling out the audio signal indicative of the first interference audio and the audio signal indicative of the second interference audio from the microphone input signal.

The device 202 may forward the microphone input signal to the AEC 212. For example, the device 202 may cause the microphone(s) 210 to send the microphone input signal to the AEC 212. The AEC 212 may receive the microphone input signal. The AEC 212 may be configured to reduce degradation due to the first interference audio and/or the second interference audio so that the device 202 can properly process the voice command or query. For example, the AEC 212 may accomplish this by cancelling out the audio signal indicative of the first interference audio and the audio signal indicative of the second interference audio from the microphone input signal. If the audio signal indicative of the first interference audio and the audio signal indicative of the second interference audio are cancelled out from the microphone input signal, all that remains of the microphone input signal may be the audio signal indicative of the voice command or query. If all that remains of the microphone input signal is the audio signal indicative of the voice command or query, it may be easier for the device 202 to process the voice command or query.

As described above with regard to FIG. 1, the AEC 212 may utilize reference signals to cancel out interference audio signals from the microphone input signal. For example, the device 202 may forward a content reference input signal 216 to the AEC 212. The content reference input signal 216 may be a reference signal associated with the first interference audio. For example, the content reference input signal 216 may provide the AEC 112 with the same audio signals that are emanating from the speakers 208a-n. The content reference input signal 216 may comprise one or more audio channels. For example, the content reference input signal 216 may comprise a quantity of audio channels corresponding to a quantity of speakers 208a-n.

The AEC 212 may utilize the content reference input signal 216 and the microphone input signals to determine the echo characteristics of the content audio stream 206. For example, the AEC 212 may utilize adaptive filtering techniques to determine the echo characteristics of the content audio stream 206 based on the content reference input signal 216 and the microphone input signals. The echo characteristics of the content audio stream 206 may indicate a direct acoustic path between the speakers 208a-n and the microphone(s) 210. The echo characteristics of the content audio stream 206 may additionally, or alternatively, indicate indirect acoustic paths between the speakers 208a-n and the microphone(s) 210. Such indirect acoustic paths may be due to the reflections of the speaker output off the walls, ceiling, floor, and/or objects in the room. The indirect path may therefore diffuse (spread out over time) with decreasing amplitude as time passes.

The device 202 may additionally forward a local reference input signal 223 to the AEC 212. The local reference input signal 223 may be associated with second interference audio. For example, the local reference input signal 223 may provide the AEC 212 with the same audio signals that are emanating from the speakers 222. The AEC 212 may utilize the local reference input signal 223 and the microphone input signals to determine the echo characteristics of the local audio stream 226. The echo characteristics of the local audio stream 226 may indicate a direct acoustic path between the speakers 222 and the microphone(s) 210. The echo characteristics of the local audio stream 226 may additionally, or alternatively, indicate indirect acoustic paths between the speakers 222 and the microphone(s) 210. Such indirect acoustic paths may be due to the reflections of the speaker output off the walls, ceiling, floor, and/or objects in the room. The indirect path may therefore diffuse (spread out over time) with decreasing amplitude as time passes.

However, as discussed above, output of the content audio via the audio output device 204 may be delayed by a delay 207. Thus, the first interference audio may arrive at the microphone(s) 210 subject to the delay 207. If the first interference audio arrives at the microphone(s) 210 subject to the delay 207, the forwarding of the content reference input signal to the AEC 212 may need to be similarly delayed. Otherwise, the AEC 212 may have difficulty canceling out the audio signal indicative of the first interference audio from the microphone input signal.

To delay the forwarding of the content reference input signal to the AEC 212 so that the AEC 212 receives the first interference audio and the content reference input signal at the same time, the device 202 may insert a bulk audio delay 215 into the content reference input signal path. For example, the device 202 may not forward the content reference input signal to the AEC 212 at the same time as the device 202 sends the content audio stream 206 via HDMI to the audio output device 204. Instead, the device 202 may wait after sending the content audio stream 206 to the audio output device 204 for the duration indicated by the bulk audio delay 215 before forward the content reference input signal to the AEC 212. In this manner, the AEC 212 may receive the content reference input signal and the audio signal indicative of the first interference audio at the same time.

The bulk delay 215 may be determined (i.e., estimated), such as by the device 202, based on the delay 207. For example, the bulk delay 215 may be equal to the delay 207. If the delay 207 is equal to a certain number of seconds or milliseconds, the bulk delay 215 may also be equal to that certain number of seconds or milliseconds. Alternatively, the bulk delay 215 may be equal to the delay 207 plus any other delays that exist the audio path between the device 202 and the audio output device 204. The delay 207 may additionally, or alternatively, vary based upon user-controlled audio settings. The delay 207 may be determined such as by the device 202, dynamically. For example, the device 202 may determine that the delay 207 has increased or decreased as video and/or audio processing conditions change. If the delay 207 increases, the bulk delay 215 may increase. Conversely, if the delay 207 decreases, the bulk delay 215 may decrease.

Delaying the forwarding of the content reference input signal to the AEC 212 may improve the ability of the AEC 212 to cancel out the first interference audio regardless of whether the audio output device 204 has one speaker, two speakers, or more than two speakers. For example, the bulk delay 215 may be the same for all speaker channels.

Inserting the bulk audio delay 215 may make the cancelling out of the first interference audio easier, less computationally intensive, and more accurate. For example, if such time alignment of the content reference input signal and the audio signal indicative of the first interference audio is not performed, the AEC 212 may need to cancel echo during time periods in which there is no echo. Cancelling echo during time periods in which there is no echo reduces the cancelling performance of the AEC, such as due to algorithmic imperfections and/or accumulated computation error. Cancelling echo during time periods in which there is no echo also drives up central processing unit (CPU) utilization, which may be an especially important concern when there are multiple speaker channels and/or multiple microphones, and/or may slow down convergence to a steady state of maximum cancellation.

The AEC 212 may utilize the (delayed) content reference input signal and the local reference input signal to learn the echo characteristics of the first and second interference audio signals, respectively. By learning the echo characteristics of the first and second interference audio signals, the AEC 212 may be able to differentiate the first and second interference audio from the voice command. In this manner, the AEC 212 may be able to cancel out the first and second interference audio signals, but not the audio signal indicative of the voice command or query, from the microphone input signal.

However, as described above, the AEC 212 may not be able to properly cancel out the first and second interference audio from the microphone input signal if the first and second interference audio signals are not captured by the microphone(s) 210 at the same time. The output of the second interference audio may be delayed so that it arrives at (i.e., is captured by) the microphone(s) 210 at the same time as the (delayed) first interference audio. Delaying the second interference audio enables the AEC 212 to properly filter out the first and second interference audio from the microphone input signal. As both the microphone(s) 210 and the speakers 222 are located on device 202 (and thus within close proximity of each other), the second interference audio may be captured by the microphone(s) 210 almost immediately after output by the device 202. Thus, the time at which the second interference audio is output may be the same as, or substantially the same as, the time at which the second interference audio is captured by the microphone(s) 210.

Output of the second interference audio may be delayed by inserting a local delay 224 into the local audio path. Insertion of the local delay 224 may synchronize the first interference audio and the second interference audio so that they arrive at (e.g., are captured by) the microphone(s) 210 at the same time. The local delay 224 may be determined, such as by the device 202, based on the bulk delay 215. For example, the local delay 224 may be equal to the bulk delay 215 minus any other delays that may exist in the local speaker output path. If no other delays exist in the local speaker output path, the local delay 224 may be equal to the bulk delay 215. Unlike the bulk audio delay 215 which is inserted into the AEC reference input, the local delay 224 is inserted into the local audio path.

Insertion of the local delay 224 into the local audio path may ensure that the first and second interference audio are captured by the microphone(s) 210 at the same time as their respective reference signals reach the AEC. Thus, insertion of the local delay 224 into the local audio path may make the cancelling out of interference audio by the AEC 212 easier, less computationally intensive, and/or more accurate. By time aligning the first and second interference audio, the need for the device 202 to estimate a second delay associated with the local audio path is eliminated. Additionally, or alternatively, time aligning the first and second interference audio eliminates the need for the AEC 212 to cancel two independent time-delayed echo tails.

If the device 202 is configured to function as a speakerphone, the above-described techniques may be utilized to cancel the interference audio (e.g., the first and second interference audio) so that the person at the other end of a conversation does not hear the interference signals. For example, either (or both) of the first and second interference audio may include the far end person's voice emanating from any or all of the speakers.

The device 202 may include one or more processor(s) 214. The device 202 may forward the post-filtering microphone input signal (i.e., the audio cancelled signal 211) to the processor(s) 214. For example, the device 202 may cause the AEC 212 to send the audio cancelled signal 211 to the processor(s) 214. The processor(s) 214 may receive the audio cancelled signal 211. In response to receiving the audio cancelled signal 211, the processor(s) 214 may determine the meaning of the voice command or query. For example, the processor(s) 214 may employ natural language processing techniques to understand the meaning of the voice command or query. The device 202 may respond to the voice query or voice command accordingly. For example, the device 202 may perform one or more actions and/or cause one or more actions to be performed in response to the voice query or voice command.

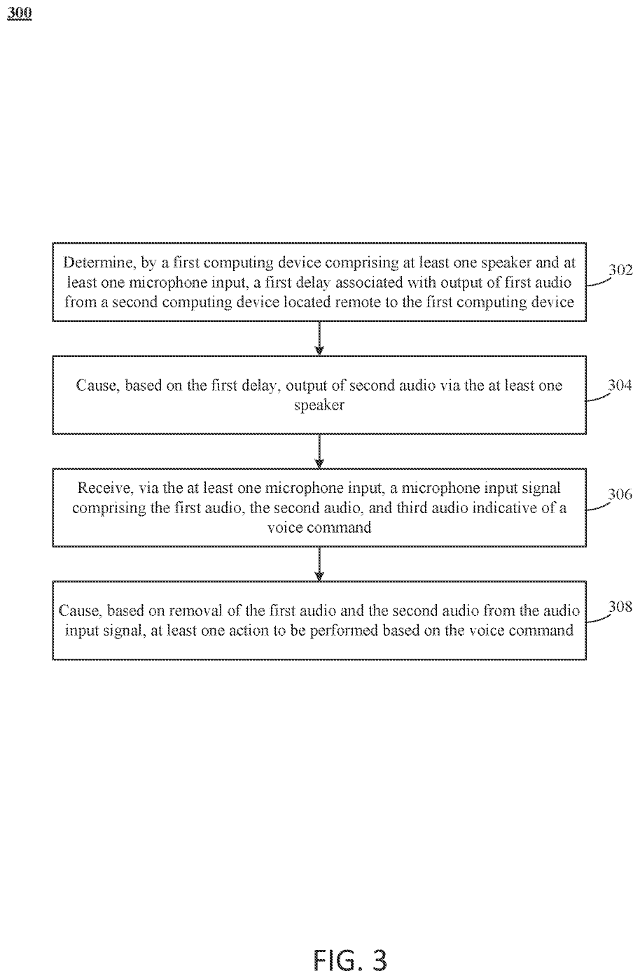

While FIG. 2 shows the example device 202, the example device 204, and the example AEC 212 as one computing device, the device 202, the audio output device 204, and/or the AEC 212 may each be implemented in one or more computing devices. Such a computing device may comprise one or more processors and memory storing instructions that, when executed by the one or more processors, cause the computing device to perform one or more of the various methods or techniques described here. The memory may comprise volatile memory (e.g., random access memory (RAM)) and/or non-volatile memory (e.g., a hard or solid-state drive). The memory may comprise a non-transitory computer-readable medium. The computing device may comprise one or more input devices, such as a mouse, a keyboard, or a touch interface. The computing device may comprise one or more output devices, such as a monitor or other video display. The computing device may comprise an audio input and/or output. The computing device may comprise one or more network communication interfaces, such as a wireless transceiver (e.g., Wi-Fi or cellular) or wired network interface (e.g., ethernet). FIG. 3 shows an example method 300. The method 300 may be used to synchronize audio output for noise cancellation. The method 300 may be performed, for example, by the computing device 202 of FIG. 2. The method 300 may be used to ensure that interference audio emanating from speakers located on a first computing device and interference audio emanating from a second computing device located remote to the first computing device are simultaneously received at (e.g., captured by) one or more microphones located on the first computing device. Simultaneously receiving the interference audio emanating from speakers located on a first computing device and the interference audio emanating from a second computing device located remote to the first computing device at one or more microphones may comprise receiving the interference audio emanating from speakers located on the first computing device and the interference audio emanating from the second computing device at substantially the same time. The first computing device may comprise an AEC. As described above, ensuring that these different interference audio signals are captured by the microphone(s) at the same time eliminates the need for the AEC to cancel two independent echo tails. Thus, performance of the method 300 may ensure that the cancelling out of interference audio by the AEC is easier, less computationally intensive, and/or more accurate.

At 302, a first delay associated with output of first audio (i.e., first interference audio) from a second computing device located remote to the first computing device may be determined. For example, the first delay may be determined by the first computing device. The first computing device may be any device configured to perform voice recognition. For example, the first computing device may any device that is configured to receive a voice query or a voice command from one or more users. The first computing device may comprise at least one speaker and at least one microphone input. For example, the first computing device may comprise a STB. The second computing device may comprise, for example, any device that is configured to output audio. For example, the second computing device may comprise at least one of a television, a smart television, a desktop computer, a laptop computer, a handheld computer, a tablet, a smartphone, and a gaming console.

The first audio may be, for example, the audio portion of content (i.e., content audio). The first computing device may be configured to cause output of the content audio via the second computing device. To cause output of the content audio via the second computing device, the first computing device may send, to the second computing device, the content audio via HDMI. However, as described above, output of the content audio via the second computing device may be delayed. For example, there may be a delay between the first computing device sending the content audio stream to the second computing device and the second computing device actually outputting the content audio via one or more speakers associated with the second computing device. The delay may, for example, result from the time that it takes the second computing device to process the content audio (or associated video) before output.

Thus, determining the first delay associated with output of the first audio from the second computing device may comprise determining an amount of time between the first computing device sending an audio signal indicative of the first audio to the second computing device and output of the first audio via the second computing device. The first delay may be determined by the first computing device dynamically. For example, the first computing device may determine that the first delay has increased or decreased as video and/or audio processing conditions change.

Interference audio may emanate from more than one audio source. For example, in addition to the first audio (i.e., first interference audio) emanating from the second computing device, second audio (i.e., second interference audio) may emanate from the speakers of the first computing device. However, as described above, an AEC may not be able to properly filter out the first and second interference audio from a microphone input signal if the first and second interference audio signals are not captured by the microphone(s) of the first computing device at the same time. For example, if the first and second interference audio signals are not captured by the microphone(s) at the same time, the AEC may need to cancel two independent echo tails. Cancelling two independent echo tails may increase the amount of work that needs to be performed by the AEC and/or may make it more difficult for the AEC to fully filter out the first and second interference audio from the microphone input signal.

Thus, it may be desirable for the first audio and the second audio to be captured by the microphone(s) of the first computing device at the same time. At 304, output of second audio via the at least one speaker may be caused based on the first delay. For example, causing output of the second audio based on the first delay may comprise determining, based on the first delay, a second delay associated with output of the second audio via the at least one speaker. The second delay may be inserted into the local audio path. Insertion of the second delay may synchronize the first audio and the second audio so that they arrive at (i.e., are captured by) the microphone(s) at the same time

To determine the second delay, an amount of time by which to delay output of the second audio via the at least one speaker so that the at least one microphone simultaneously receives the first audio and the second audio may be determined. The second delay may be equal to the first delay less any delay that may exist in the local audio path. For example, the second delay may be equal to the first delay less the amount of time between the sending of an audio signal indicative of the second audio to the at least one speaker and output of the second audio via the at least one speaker. For example, if the first delay is 120 milliseconds, the second delay may be 120 milliseconds less the amount of time between the sending of an audio signal indicative of the second audio to the at least one speaker and output of the second audio via the at least one speaker. Output of the second audio may be initiated at a time determined based on the second delay.

The first audio emanating from the second computing device and the second audio emanating from the first computing device may be captured by the at least one microphone. The at least one microphone may additionally capture a voice command or query. A voice query or command may be, for example, a spoken command to the first computing device to perform some action, a spoken request to view or play some particular content, a spoken request to search for certain content or information based on search criteria, or any other spoken request or command that may be spoken by a user. At 306, a microphone input signal comprising the first audio, the second audio, and third audio indicative of a voice command may be received via the at least one microphone input.

The microphone input signal may be forwarded to an AEC. The AEC may cancel out the interference audio signals from the microphone input signal, so that only the voice command audio signal remains. For example, the AEC may cancel out the first and second audio from the microphone input signal. If the AEC cancels out the first and second audio from the microphone input signal, all that remains of the microphone input signal may be the third audio indicative of a voice command. At 308, a filtered audio signal may be generated by removing the first audio and the second audio from the microphone input signal.

The cancelled audio signal may then be forwarded to a processor that is configured to determine the voice command and respond accordingly. At 310, the cancelled audio signal may be processed to determine the voice command. As the AEC has cancelled out the interference audio signals from the microphone input signal, the interference audio signals may not interfere with the processor's ability to determine the voice command. At 312, performance of at least one action may be caused based on the determined voice command. For example, if it is determined that the voice command is to “tune to channel 4,” the first computing device may respond to the voice command, for example, by causing tuning to the desired channel (i.e., channel 4).

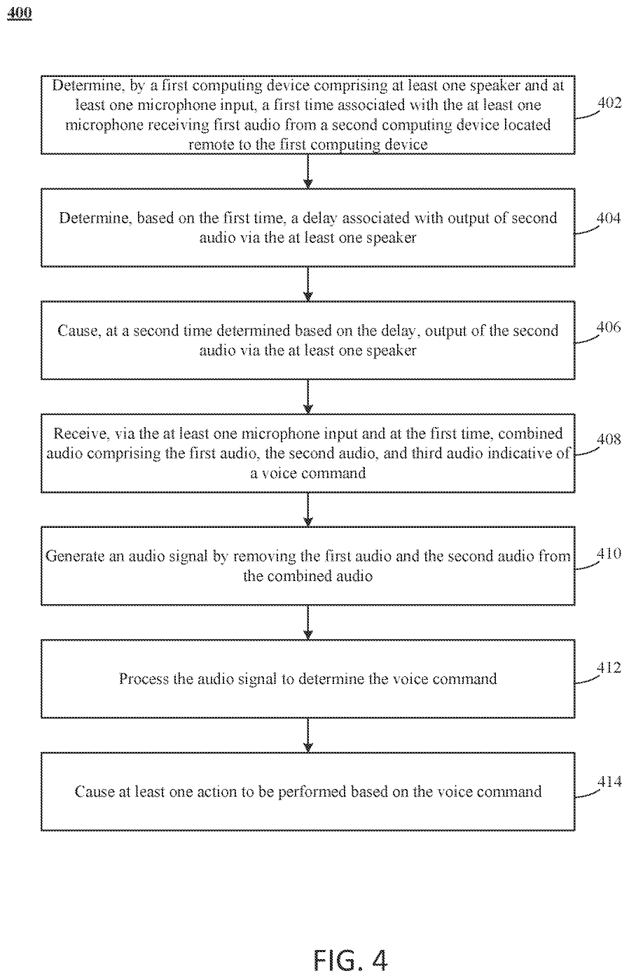

FIG. 4 shows an example method 400. The method 400 may be used to synchronize audio output for noise cancellation. The method 400 may be performed, for example, by the computing device 202 of FIG. 2. The method 400 may be used to ensure that interference audio emanating from speakers located on a first computing device and interference audio emanating from a second computing device located remote to the first computing device are simultaneously received at (i.e., captured by) one or more microphones located on the first computing device. Simultaneously receiving the interference audio emanating from speakers located on a first computing device and the interference audio emanating from a second computing device located remote to the first computing device at one or more microphones may comprise receiving the interference audio emanating from speakers located on the first computing device and the interference audio emanating from the second computing device at substantially the same time. The first computing device may comprise an AEC. As described above, ensuring that these different interference audio signals are captured by the microphone(s) at the same time eliminates the need for the AEC to cancel two independent echo tails. Thus, performance of the method 400 may ensure that the cancelling out of interference audio by the AEC is easier, less computationally intensive, and/or more accurate.

A first computing device may comprise at least one speaker and at least one microphone input. At 402, a first time associated with the at least one microphone receiving first audio (i.e., first interference audio) from a second computing device located remote to the first computing device may be determined. For example, the first time may be determined by the first computing device.

The first computing device may be any device configured to perform voice recognition. For example, the first computing device may any device that is configured to receive a voice query or a voice command from one or more users. The first computing device may comprise at least one speaker and at least one microphone input. For example, the first computing device may comprise a STB. The second computing device may comprise, for example, any device that is configured to output audio. For example, the second computing device may comprise at least one of a television, a smart television, a desktop computer, a laptop computer, a handheld computer, a tablet, a smartphone, and a gaming console.

The first audio may be, for example, the audio portion of content (i.e., content audio). The first computing device may be configured to cause output of the content audio via the second computing device. To cause output of the content audio via the second computing device, the first computing device may send, to the second computing device, the content audio via HDMI. The second computing device may receive the content audio via HDMI and process the content audio. The second computing device may output the processed content audio via one or more speakers associated with the second computing device.

Interference audio may emanate from more than one audio source. For example, in addition to the first audio (i.e., first interference audio) emanating from the second computing device, second audio (i.e., second interference audio) may emanate from the speakers of the first computing device. However, as described above, an AEC may not be able to properly filter out the first and second interference audio from a microphone input signal if the first and second interference audio signals are not captured by the microphone(s) of the first computing device at the same time. For example, if the first and second interference audio signals are not captured by the microphone(s) at the same time, the AEC may need to cancel two independent echo tails. Cancelling two independent echo tails may increase the amount of work that needs to be performed by the AEC and/or may make it more difficult for the AEC to fully filter out the first and second interference audio from the microphone input signal.

Thus, it may be desirable for the first audio and the second audio to be captured by the microphone(s) of the first computing device at the same time. At 404, a delay associated with output of second audio via the at least one speaker may be determined based on the first time. To determine the delay, an amount of time by which to delay output of the second audio via the at least one speaker so that the at least one microphone receives the second audio at the first time may be determined. At 406, output of the second audio via the at least one speaker may be caused at a second time. The second time may be determined based on the delay. For example, the delay may be inserted into the local audio path. Insertion of the delay may synchronize the first audio and the second audio so that they arrive at (i.e., are captured by) the microphone(s) at the same time (i.e., the first time).

The first audio emanating from the second computing device and the second audio emanating from the first computing device may be captured by the at least one microphone. The at least one microphone may additionally capture a voice command or query. A voice query or command may be, for example, a spoken command to the first computing device to perform some action, a spoken request to view or play some particular content, a spoken request to search for certain content or information based on search criteria, or any other spoken request or command that may be spoken by a user. At 408, combined audio comprising the first audio, the second audio, and third audio indicative of a voice command may be received. The combined audio may be received via the at least one microphone input and at the first time.

The microphone input signal may be forwarded to an AEC. The AEC may filter out the interference audio signals from the microphone input signal, so that only the voice command audio signal remains. For example, the AEC may filter out the first and second audio from the microphone input signal. If the AEC filters out the first and second audio from the microphone input signal, all that remains of the microphone input signal may be the third audio indicative of a voice command. At 410, a filtered audio signal may be generated by removing the first audio and the second audio from the microphone input signal.

The filtered audio signal may then be forwarded to a processor that is configured to determine the voice command and respond accordingly. At 412, the filtered audio signal may be processed to determine the voice command. As the AEC has filtered out the interference audio signals from the microphone input signal, the interference audio signals may not interfere with the processor's ability to determine the voice command. At 414, performance of at least one action may be caused based on the determined voice command. For example, if it is determined that the voice command is to “tune to channel 4,” the first computing device may respond to the voice command, for example, by causing tuning to the desired channel (i.e., channel 4).

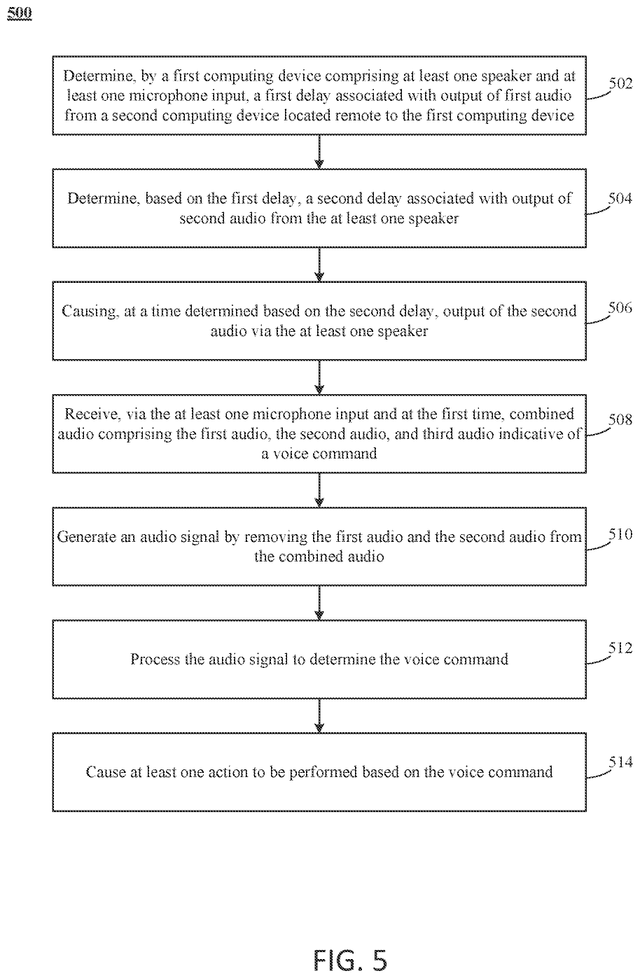

FIG. 5 shows an example method 500. The method 500 may be used to synchronize audio output for noise cancellation. The method 500 may be performed, for example, by the computing device 202 of FIG. 2. The method 500 may be used to ensure that interference audio emanating from speakers located on a first computing device and interference audio emanating from a second computing device located remote to the first computing device are simultaneously received at (i.e., captured by) one or more microphones located on the first computing device. Simultaneously receiving the interference audio emanating from speakers located on a first computing device and the interference audio emanating from a second computing device located remote to the first computing device at one or more microphones may comprise receiving the interference audio emanating from speakers located on the first computing device and the interference audio emanating from the second computing device at substantially the same time. The first computing device may comprise an AEC. As described above, ensuring that these different interference audio signals are captured by the microphone(s) at the same time eliminates the need for the AEC to cancel two independent echo tails. Thus, performance of the method 500 may ensure that the cancelling out of interference audio by the AEC is easier, less computationally intensive, and/or more accurate.

At 502, a first delay associated with output of first audio (i.e., first interference audio) from a second computing device located remote to the first computing device may be determined. For example, the first delay may be determined by the first computing device. The first computing device may be any device configured to perform voice recognition. For example, the first computing device may any device that is configured to receive a voice query or a voice command from one or more users. The first computing device may comprise at least one speaker and at least one microphone input. For example, the first computing device may comprise a STB. The second computing device may comprise, for example, any device that is configured to output audio. For example, the second computing device may comprise at least one of a television, a smart television, a desktop computer, a laptop computer, a handheld computer, a tablet, a smartphone, and a gaming console.

The first audio may be, for example, the audio portion of content (i.e., content audio). The first computing device may be configured to cause output of the content audio via the second computing device. To cause output of the content audio via the second computing device, the first computing device may send, to the second computing device, the content audio via HDMI. However, as described above, output of the content audio via the second computing device may be delayed. For example, there may be a delay between the first computing device sending the content audio stream to the second computing device and the second computing device actually outputting the content audio via one or more speakers associated with the second computing device. The delay may, for example, result from the time that it takes the second computing device to process the content audio before output.

Thus, determining the first delay associated with output of the first audio from the second computing device may comprise determining an amount of time between the first computing device sending an audio signal indicative of the first audio to the second computing device and output of the first audio via the second computing device. The first delay may be determined by the first computing device dynamically. For example, the first computing device may determine that the first delay has increased or decreased as video and/or audio processing conditions change.

Interference audio may emanate from more than one audio source. For example, in addition to the first audio (i.e., first interference audio) emanating from the second computing device, second audio (i.e., second interference audio) may emanate from the speakers of the first computing device. However, as described above, an AEC may not be able to properly filter out the first and second interference audio from a microphone input signal if the first and second interference audio signals are not captured by the microphone(s) of the first computing device at the same time. For example, if the first and second interference audio signals are not captured by the microphone(s) at the same time, the AEC may need to cancel two independent echo tails. Cancelling two independent echo tails may increase the amount of work that needs to be performed by the AEC and/or may make it more difficult for the AEC to fully filter out the first and second interference audio from the microphone input signal.

Thus, it may be desirable for the first audio and the second audio to be captured by the microphone(s) of the first computing device at the same time. At 504, a second delay associated with output of second audio from the at least one speaker may be determined based on the first delay.

To determine the second delay, an amount of time by which to delay output of the second audio via the at least one speaker so that the at least one microphone simultaneously receives the first audio and the second audio may be determined. The second delay may, for example, be equal to the first delay less any delay that may exist in the local audio path. For example, the second delay may be equal to the first delay less the amount of time between the sending of an audio signal indicative of the second audio to the at least one speaker and output of the second audio via the at least one speaker. For example, if the first delay is 120 milliseconds, the second delay may be 120 milliseconds less the amount of time between the sending of an audio signal indicative of the second audio to the at least one speaker and output of the second audio via the at least one speaker.

Output of the second audio may be initiated at a time determined based on the second delay. At 506, output of the second audio via the at least one speaker may be caused at a time determined based on the second delay. For example, causing output of the second audio may comprise inserting the second delay into the local audio path. Insertion of the second delay into the local audio path may synchronize the first audio and the second audio so that they arrive at (i.e., are captured by) the microphone(s) at the same time.

The first audio emanating from the second computing device and the second audio emanating from the first computing device may be captured by the at least one microphone. The at least one microphone may additionally capture a voice command or query. A voice query or command may be, for example, a spoken command to the first computing device to perform some action, a spoken request to view or play some particular content, a spoken request to search for certain content or information based on search criteria, or any other spoken request or command that may be spoken by a user. At 508, combined audio comprising the first audio, the second audio, and third audio indicative of a voice command may be received. The combined audio may be received via the at least one microphone input and at the first time.

The microphone input signal may be forwarded to an AEC. The AEC may filter out the interference audio signals from the microphone input signal, so that only the voice command audio signal remains. For example, the AEC may filter out the first and second audio from the microphone input signal. If the AEC filters out the first and second audio from the microphone input signal, all that remains of the microphone input signal may be the third audio indicative of a voice command. At 510, a filtered audio signal may be generated by removing the first audio and the second audio from the microphone input signal.

The filtered audio signal may then be forwarded to a processor that is configured to determine the voice command and respond accordingly. At 512, the filtered audio signal may be processed to determine the voice command. As the AEC has filtered out the interference audio signals from the microphone input signal, the interference audio signals may not interfere with the processor's ability to determine the voice command. At 514, performance of at least one action may be caused based on the determined voice command. For example, if it is determined that the voice command is to “tune to channel 4,” the first computing device may respond to the voice command, for example, by causing tuning to the desired channel (i.e., channel 4).

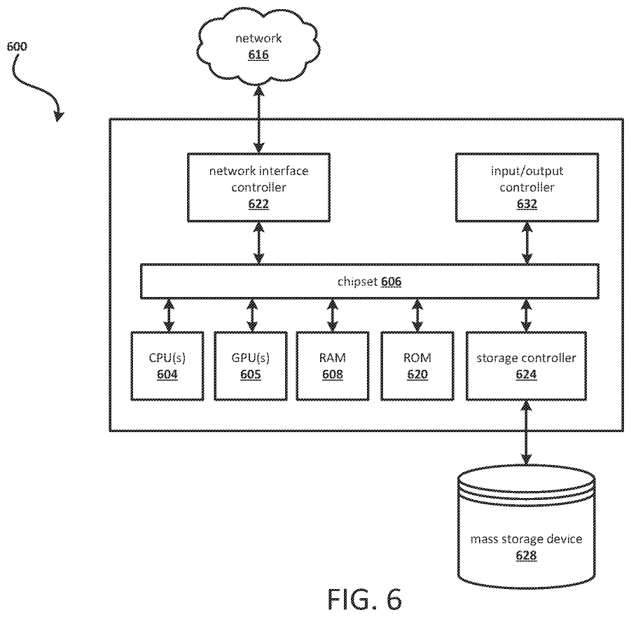

FIG. 6 depicts an example computing device 600 that may be used to implement any of the various devices or entities illustrated in FIGS. 1-2. That is, the computing device 600 shown in FIG. 6 may be any smartphone, server computer, workstation, access point, router, gateway, tablet computer, laptop computer, notebook computer, desktop computer, personal computer, network appliance, PDA, e-reader, user equipment (UE), mobile station, fixed or mobile subscriber unit, pager, wireless sensor, consumer electronics, or other computing device, and may be utilized to execute any aspects of the methods and apparatus described herein, such as to implement any of the apparatus of FIGS. 1-2 or the methods described in relation to FIG. 3-5.

The computing device 600 may include a baseboard, or “motherboard,” which is a printed circuit board to which a multitude of components or devices may be connected by way of a system bus or other electrical communication paths. One or more central processing units (CPUs or “processors”) 604 may operate in conjunction with a chipset 606. The CPU(s) 604 may be standard programmable processors that perform arithmetic and logical operations necessary for the operation of the computing device 600.

The CPU(s) 604 may perform the necessary operations by transitioning from one discrete physical state to the next through the manipulation of switching elements that differentiate between and change these states. Switching elements may generally include electronic circuits that maintain one of two binary states, such as flip-flops, and electronic circuits that provide an output state based on the logical combination of the states of one or more other switching elements, such as logic gates. These basic switching elements may be combined to create more complex logic circuits including registers, adders-subtractors, arithmetic logic units, floating-point units, and the like.

The CPU(s) 604 may be augmented with or replaced by other processing units, such as GPU(s) 606. The GPU(s) 606 may comprise processing units specialized for but not necessarily limited to highly parallel computations, such as graphics and other visualization-related processing.

A chipset 606 may provide an interface between the CPU(s) 604 and the remainder of the components and devices on the baseboard. The chipset 606 may provide an interface to a random access memory (RAM) 608 used as the main memory in the computing device 600. The chipset 606 may provide an interface to a computer-readable storage medium, such as a read-only memory (ROM) 620 or non-volatile RAM (NVRAM) (not shown), for storing basic routines that may help to start up the computing device 600 and to transfer information between the various components and devices. ROM 620 or NVRAM may also store other software components necessary for the operation of the computing device 600 in accordance with the aspects described herein.

The computing device 600 may operate in a networked environment using logical connections to remote computing nodes and computer systems of the communications network 100. The chipset 606 may include functionality for providing network connectivity through a network interface controller (NIC) 622. A NIC 622 may be capable of connecting the computing device 600 to other computing nodes over the communications network 100. It should be appreciated that multiple NICs 622 may be present in the computing device 600, connecting the computing device to other types of networks and remote computer systems. The NIC may be configured to implement a wired local area network technology, such as IEEE 802.3 (“Ethernet”) or the like. The NIC may also comprise any suitable wireless network interface controller capable of wirelessly connecting and communicating with other devices or computing nodes on the communications network 100. For example, the NIC 622 may operate in accordance with any of a variety of wireless communication protocols, including for example, the IEEE 802.11 (“Wi-Fi”) protocol, the IEEE 802.16 or 802.20 (“WiMAX”) protocols, the IEEE 802.16.4a (“Zigbee”) protocol, the 802.16.3c (“UWB”) protocol, or the like.

The computing device 600 may be connected to a mass storage device 628 that provides non-volatile storage (i.e., memory) for the computer. The mass storage device 628 may store system programs, application programs, other program modules, and data, which have been described in greater detail herein. The mass storage device 628 may be connected to the computing device 600 through a storage controller 624 connected to the chipset 606. The mass storage device 628 may consist of one or more physical storage units. A storage controller 624 may interface with the physical storage units through a serial attached SCSI (SAS) interface, a serial advanced technology attachment (SATA) interface, a fiber channel (FC) interface, or other type of interface for physically connecting and transferring data between computers and physical storage units.

The computing device 600 may store data on a mass storage device 628 by transforming the physical state of the physical storage units to reflect the information being stored. The specific transformation of a physical state may depend on various factors and on different implementations of this description. Examples of such factors may include, but are not limited to, the technology used to implement the physical storage units and whether the mass storage device 628 is characterized as primary or secondary storage and the like.

For example, the computing device 600 may store information to the mass storage device 628 by issuing instructions through a storage controller 624 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computing device 600 may read information from the mass storage device 628 by detecting the physical states or characteristics of one or more particular locations within the physical storage units.

In addition to the mass storage device 628 described herein, the computing device 600 may have access to other computer-readable storage media to store and retrieve information, such as program modules, data structures, or other data. It should be appreciated by those skilled in the art that computer-readable storage media may be any available media that provides for the storage of non-transitory data and that may be accessed by the computing device 600.

By way of example and not limitation, computer-readable storage media may include volatile and non-volatile, non-transitory computer-readable storage media, and removable and non-removable media implemented in any method or technology. However, as used herein, the term computer-readable storage media does not encompass transitory computer-readable storage media, such as signals. Computer-readable storage media includes, but is not limited to, RAM, ROM, erasable programmable ROM (“EPROM”), electrically erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage, other magnetic storage devices, or any other non-transitory medium that may be used to store the desired information in a non-transitory fashion.

A mass storage device, such as the mass storage device 628 depicted in FIG. 6, may store an operating system utilized to control the operation of the computing device 600. The operating system may comprise a version of the LINUX operating system. The operating system may comprise a version of the WINDOWS SERVER operating system from the MICROSOFT Corporation. According to additional aspects, the operating system may comprise a version of the UNIX operating system. Various mobile phone operating systems, such as IOS and ANDROID, may also be utilized. It should be appreciated that other operating systems may also be utilized. The mass storage device 628 may store other system or application programs and data utilized by the computing device 600.

The mass storage device 628 or other computer-readable storage media may also be encoded with computer-executable instructions, which, when loaded into the computing device 600, transforms the computing device from a general-purpose computing system into a special-purpose computer capable of implementing the aspects described herein. These computer-executable instructions transform the computing device 600 by specifying how the CPU(s) 604 transition between states, as described herein. The computing device 600 may have access to computer-readable storage media storing computer-executable instructions, which, when executed by the computing device 600, may perform the methods described in relation to FIG. 3-5.

A computing device, such as the computing device 600 depicted in FIG. 6, may also include an input/output controller 632 for receiving and processing input from a number of input devices, such as a keyboard, a mouse, a touchpad, a touch screen, an electronic stylus, or other type of input device. Similarly, an input/output controller 632 may provide output to a display, such as a computer monitor, a flat-panel display, a digital projector, a printer, a plotter, or other type of output device. It will be appreciated that the computing device 600 may not include all of the components shown in FIG. 6, may include other components that are not explicitly shown in FIG. 6, or may utilize an architecture completely different than that shown in FIG. 6.

As described herein, a computing device may be a physical computing device, such as the computing device 600 of FIG. 6. A computing device may also include a virtual machine host process and one or more virtual machine instances. Computer-executable instructions may be executed by the physical hardware of a computing device indirectly through interpretation and/or execution of instructions stored and executed in the context of a virtual machine.

One skilled in the art will appreciate that the systems and methods disclosed herein may be implemented via a computing device that may comprise, but are not limited to, one or more processors, a system memory, and a system bus that couples various system components including the processor to the system memory. In the case of multiple processors, the system may utilize parallel computing.

For purposes of illustration, application programs and other executable program components such as the operating system are illustrated herein as discrete blocks, although it is recognized that such programs and components reside at various times in different storage components of the computing device and are executed by the data processor(s) of the computer. An implementation of service software may be stored on or transmitted across some form of computer-readable media. Any of the disclosed methods may be performed by computer-readable instructions embodied on computer-readable media. Computer-readable media may be any available media that may be accessed by a computer. By way of example and not meant to be limiting, computer-readable media may comprise “computer storage media” and “communications media.” “Computer storage media” comprise volatile and non-volatile, removable and non-removable media implemented in any methods or technology for storage of information such as computer-readable instructions, data structures, program modules, or other data. Exemplary computer storage media comprises, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by a computer. Application programs and the like and/or storage media may be implemented, at least in part, at a remote system.

As used in the specification and the appended claims, the singular forms “a,” “an” and “the” include plural referents unless the context clearly dictates otherwise. Ranges may be expressed herein as from “about” one particular value, and/or to “about” another particular value. Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect.

It will be apparent to those skilled in the art that various modifications and variations may be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

What is claimed is:

1. A method comprising:
determining, by a first computing device comprising at least one audio output and at least one audio input, a first delay associated with output of first audio from a second computing device located remote to the first computing device;
causing, based on the first delay, output of second audio via the at least one audio output;
receiving, via the at least one audio input, an audio input signal comprising the first audio, the second audio, and third audio indicative of a voice command; and
causing, based on removal of the first audio and the second audio from the audio input signal, at least one action to be performed based on the voice command.

2. The method of claim 1, wherein determining the first delay associated with output of first audio from the second computing device comprises:
determining an amount of time between the first computing device sending an audio signal indicative of the first audio to the second computing device and output of the first audio via the second computing device.

3. The method of claim 1, wherein causing, based on the first delay, output of the second audio via the at least one audio output comprises:
determining, based on the first delay, a second delay associated with output of the second audio via the at least one audio output; and
initiating, at a time determined based on the second delay, output of the second audio.

4. The method of claim 3, wherein the second delay is equal to the first delay less an amount of time between sending of an audio signal indicative of the second audio to the at least one audio output and output of the second audio via the at least one audio output.

5. The method of claim 3, wherein determining, based on the first delay, the second delay associated with output of the second audio via the at least one audio output comprises:
determining an amount of time by which to delay output of the second audio via the at least one audio output so that the at least one audio input receives the first audio and the second audio at a same time.

6. The method of claim 1, wherein causing, based on removal of the first audio and the second audio from the audio input signal, the at least one action to be performed based on the voice command comprises:
generating a cancelled audio signal by removing the first audio and the second audio from the audio input signal; and
processing the cancelled audio signal to determine the voice command.

7. The method of claim 1, wherein the first computing device comprises a set-top box.

8. The method of claim 1, wherein the second computing device comprises at least one of a television, a smart television, a desktop computer, a laptop computer, a handheld computer, a tablet, a smartphone, and a gaming console.

9. A method comprising:
determining, by a first computing device comprising at least one audio output and at least one audio input, a first time associated with the at least one audio input receiving first audio from a second computing device located remote to the first computing device;
determining, based on the first time, a delay associated with output of second audio via the at least one audio output; and
causing, at a second time determined based on the delay, output of the second audio via the at least one audio output.

10. The method of claim 9, further comprising:
receiving, via the at least one audio input and at the first time, combined audio comprising the first audio, the second audio, and third audio indicative of a voice command.

11. The method of claim 10, further comprising:
generating an audio signal by removing the first audio and the second audio from the combined audio; and
processing the audio signal to determine the voice command.

12. The method of claim 11, further comprising:
causing at least one action to be performed based on the voice command.

13. The method of claim 9, wherein determining, based on the first time, the delay associated with output of the second audio comprises determining an amount of time by which to delay output of the second audio via the at least one audio output so that the at least one audio input receives the second audio at the first time.

14. The method of claim 9, wherein the first computing device comprises a set-top box.

15. A method comprising:
determining, by a first computing device comprising at least one audio output and at least one audio input, a first delay associated with output of first audio from a second computing device located remote to the first computing device;
determining, based on the first delay, a second delay associated with output of second audio from the at least one audio output; and
causing, at a time determined based on the second delay, output of the second audio via the at least one audio output.

16. The method of claim 15, wherein determining the first delay associated with output of first audio from the second computing device comprises:
determining an amount of time between the first computing device sending an audio signal indicative of the first audio to the second computing device and output of the first audio via the second computing device.

17. The method of claim 15, wherein determining, based on the first delay, the second delay associated with output of the second audio via the at least one audio output comprises:
determining an amount of time by which to delay output of the second audio via the at least one audio output so that the at least one audio input receives the first audio and the second audio at a same time.

18. The method of claim 15, wherein causing, based on the second delay, output of the second audio via the at least one audio output comprises:
causing, at a time determined based on the second delay, output of the second audio via the at least one audio output.

19. The method of claim 15, further comprising:
receiving, via the at least one audio input, combined audio comprising the first audio, the second audio, and third audio indicative of a voice command;
generating an audio signal by removing the first audio and the second audio from the combined audio; and
processing the audio signal to determine the voice command.

20. The method of claim 15, further comprising:
causing at least one action to be performed based on the voice command.
